(19) United States
(12) Patent Application Publication
(10) Pub. No.: US 2013/0206972 A1
(43) Pub. Date: Aug. 15, 2013

(54) NEUTRON DETECTION BASED ON A BORON SHIELDED GAMMA DETECTOR

(71) Applicants: Tong Zhou, Sugar Land, TX (US); David Rose, Sugar Land, TX (US); Sicco Beekman, Houston, TX (US); Christian Stoller, Princeton, NJ (US)

(72) Inventors: Tong Zhou, Sugar Land, TX (US); David Rose, Sugar Land, TX (US); Sicco Beekman, Houston, TX (US); Christian Stoller, Princeton, NJ (US)

(73) Assignee: SCHLUMBERGER TECHNOLOGY CORPORATION, Sugar Land, TX (US)

(21) Appl. No.: 13/807,694

(22) PCT Filed: Jun. 26, 2011
(86) PCT No.: PCT/US11/41929

§ 371 Date: Apr. 18, 2013

Related U.S. Application Data
(60) Provisional application No. 61/360,345, filed on Jun. 30, 2010.

(51) Int. Cl. G01T 3/06; G01T 1/20; G01V 11/00

(52) U.S. Cl. CPC G01T 3/06; G01V 11/00; G01T 1/20
USPC 250/269.4; 250/390.11; 250/370.05

(57) ABSTRACT

A method is provided to detect neutrons using a boron-shielded gamma-ray detector, which will detect the 0.48-MeV prompt gamma ray due to the ¹⁰B (n,α)⁷Li reaction. The gamma ray detector can be a proportional gas counter, a scintillation based detector, or a semiconductor detector. Monoenergetic prompt gammas will produce a sharp peak in the pulse height spectrum of a gamma-ray spectroscopy detector. By surrounding a gamma detector with a layer containing ¹⁰B, we can measure the gamma signal and neutron signal at the same time and at the same physical location in an instrument. The approach can be used to measure neutron porosity simultaneous with gamma-ray counting or spectroscopy at the same location as long as the 0.48-keV gamma-ray from the neutron reaction does not interfere with the gamma-ray measurement.

### TECHNICAL FIELD

The invention relates generally to neutron detection based on a boron shielded gamma ray detector.

### BACKGROUND

Neutron detectors play an important role in many nuclear measurements. This includes among others neutron measurements in industrial applications, homeland security, neutron physics and also in oil well logging measurements using neutron sources. At present, two kinds of neutron detectors are used in downhole tools. One type of detector serves to detect fast neutrons and may employ a plastic scintillation detector. A second, more common type is a detector of thermal or epithermal neutrons such as a ³He detector or, less frequently, a scintillation detector using ⁶Li-glass. ³He detectors are excellent detectors of thermal or epithermal neutrons and they are virtually insensitive to gamma-rays. ⁶Li on the other hand has significant gamma-ray sensitivity and suppression or subtraction of gamma-ray induced background in the presence of gamma-rays from inelastic neutron interactions or neutron capture is difficult and inaccurate.

Neutron detection is used in a multitude of downhole tools. The basic application is in the measurement of neutron porosity through the detection of thermal or epithermal neutrons. Other applications may include the determination of neutron-gamma-density (see patents U.S. Pat. No. 5,608,215 and U.S. Pat. No. 5,804,820, assigned to the assignee of the present disclosure). In addition, the present scarceness of ³He, a gas which is widely used in thermal and epithermal neutron detectors, has made alternatives for neutron detection to be of great interest.

### BRIEF DESCRIPTION OF THE DRAWINGS

FIG. 1 shows a schematic of neutron detection according to the present disclosure.

FIG. 2 shows a typical spectrum measured in a boron-shielded detector, with the boron peak highlighted.

FIG. 3 shows a graph of neutron absorption rate in the boron shield plotted against the count rate under the boron peak in the gamma detector, in accordance with the present disclosure.

FIG. 4 shows a basic tool using the method of the invention.

FIG. 5 shows a schematic of a scintillator surrounded by ¹⁰B shielding except on the PMT side, the PMT having an entrance window with high ¹⁰B content.

FIGS. 6A and 6B show an alternative two-layer scintillator for enhanced neutron detection in accordance with embodiments of the present disclosure.

FIGS. 7A and 7B show an alternative segmented crystal with boron layers in accordance with embodiments of the present disclosure.

FIG. 8 shows an alternative scintillator configuration having two PMTs to optimize spectral performance in accordance with embodiments of the present disclosure.

### DETAILED DESCRIPTION

In the following description, numerous details are set forth to provide an understanding of the present disclosure. However, it will be understood by those skilled in the art that the present invention may be practiced without these details and that numerous variations or modifications from the described embodiments are possible.

Here, we present an apparatus and method for detecting neutrons using a boron-shielded gamma-ray detector, which will detect the 0.48-MeV prompt gamma ray due to the ¹⁰B (n,α)⁷Li reaction. The gamma ray detector can be a proportional gas counter, a scintillation based detector, or a semiconductor detector. Monoenergetic prompt gammas will produce a sharp peak in the pulse height spectrum of a gamma-ray spectroscopy detector. The count rate in the peak is proportional to the neutron interaction rate with the ¹⁰B isotope. Natural boron contains about 20% of ¹⁰B. If one surrounds a gamma detector with a layer containing ¹⁰B, one can measure the gamma signal and neutron signal at the same time and at the same physical location in an instrument. This technique requires very little effort to apply to many neutron logging tools with gamma detectors. In particular, the approach can be used to measure neutron porosity simultaneous with gamma-ray counting or spectroscopy at the same location as long as the 0.48 MeV gamma-ray from the neutron reaction does not interfere with the gamma-ray measurement.

Boron is a very good thermal neutron absorber due to the high absorption cross section of ¹⁰B, which has 19.8% abundance in the natural boron. Enriched Boron is readily available to increase the absorption probability further.

The thermal neutron interaction with ¹⁰B is the (n,α)⁷Li reaction shown in Equation 1 below.

$${}_{5}^{10} B + {}_{0}^{1} n \to \{ \begin{matrix}{}_{3}^{7} Li + {}_{2}^{4} α & Q = 2.792 MeV ( ground state ) 6 \% \\ {}_{3}^{7}{Li}{}_{}^{*} + {}_{2}^{4} α & Q = 2.310 MeV ( excited state ) 94 \%\end{matrix} \qquad ( 1 )$$

This interaction will release a total energy of 2.792 MeV with the reaction product ⁷Li in the ground state or 2.310 MeV with the ⁷Li in the excited state. The latter reaction will happen 94% of the time. ⁷Li in the excited state will immediately decay to the ground state and release a gamma ray with energy of 0.48 MeV.

It is well known that neutrons are neutral in charge and thus require conversion to detectable particles. One of the most popular thermal neutron conversion reactions is the ¹⁰B(n,α)⁷Li reaction. The large amount of energy is shared by ⁷Li and alpha particles, which can ionize matter and generate electronic signals in a detector. The most common use of the ¹⁰B neutron reaction for neutron detection is in the BF₃ gas-proportional counter and, more recently, in proportional counters (straw detectors) with ¹⁰B lined walls intended to replace ³He detectors in several homeland security applications. The BF₃ neutron detector is well documented in text books and widely used in universities, laboratory and industry.

However, the 0.48 MeV gamma ray, which is present in 94% of the neutron reactions and can be easily detected by a modern gamma detector, has been ignored. The method disclosed herein is a method to detect thermal neutrons based on the 0.48 MeV prompt gamma from the ¹⁰B(n,α) reaction.

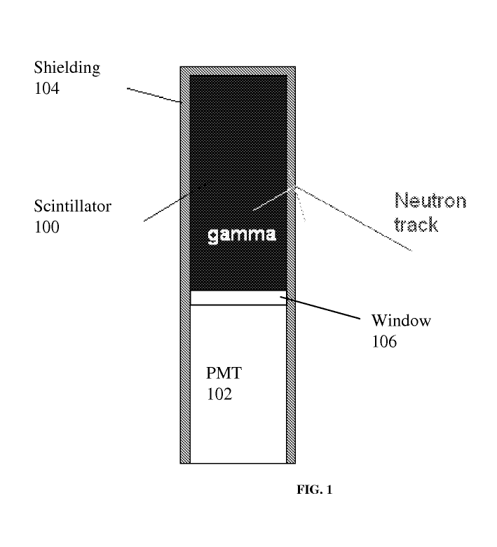

FIG. 1 shows a schematic of the neutron detection in accordance with an embodiment of the present disclosure. The gamma ray detector scintillator 100 and photomultiplier tube 102 (PMT), coupled by an optical window 106, are surrounded by a thin shielding layer containing boron 104. The thickness of the boron containing layer 104 should be sufficient to absorb almost all thermal neutrons. When a neutron is absorbed by the boron containing layer 104, it will emit ⁷Li and alpha particles and a gamma ray 94% of the time. The Li and alpha particles are heavy charged particles so that they can be easily shielded either by the boron shielding 104 itself, the thin detector housing, or the optical reflector typically surrounding a scintillation crystal 100, while the 0.48 MeV gamma ray will penetrate the boron containing shielding layer 104 and detector housing, and often deposit all its energy in the detector. Thus, the 0.48-MeV peak in the detector's gamma ray spectrum corresponds to neutrons absorbed in the boron containing shielding layer 104.

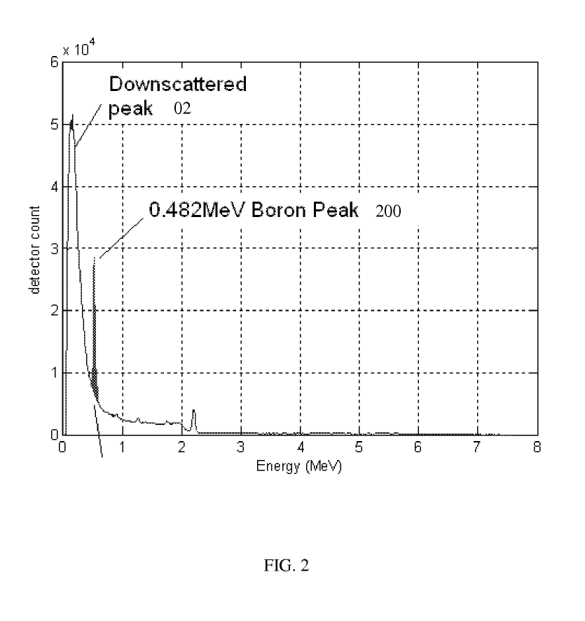

Since this prompt gamma-ray is monoenergetic, it will produce a sharp peak in a detector with sufficient resolution. FIG. 2 shows a typical spectrum measured in a boron-shielded detector of FIG. 1, with the boron peak highlighted. One method of determining a signal that is representative of the neutron signal is to determine only the counts in the boron full energy peak, and separate the peak from the larger down-scattered peak. This separation requires some basic fitting techniques, such as a polynomial fit and exponential fit, or another appropriate functional form to the part of the spectrum before and after the boron peak in order to subtract the background. FIG. 2 shows the boron peak 200 which is separated from the down-scattered section 202 of the spectrum. An alternate method is to sum all the counts in the boron energy window, which would give a higher count rate with better statistics, but would also have a significant contribution from gamma rays that would not be representative of thermal or epithermal neutrons interacting with the boron containing shielding layer 104 surrounding the scintillator 100. In the worst scenario, the boron peak 200 will have some contamination from other gamma rays, but its total area will remain dominated by the 0.48-MeV gamma-ray from the neutron interaction.

In most neutron induced gamma-ray spectra, there will be a prominent 511-keV gamma-ray line from the annihilations of positrons created by electron-positron pair production. With a detector of sufficient energy resolution, it is possible to separate the two lines located at 0.48 MeV and 0.511 MeV respectively. If the peaks overlap due to limited detector resolution, sophisticated fitting can be used to isolate the contribution from the two separate lines. This can be achieved by fitting two Gaussians and a background to the two peaks. The background may be assumed to be linear under the two peaks, but could have different form such as an exponential or a higher order polynomial. Standard spectra could also be used to separate the Boron peak from the 511 peak.

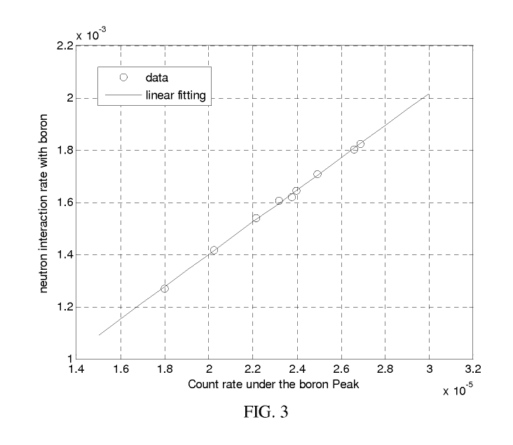

Using modeling techniques, we can calculate the neutron absorption rate in the boron shield 104 and the gamma detection probability in the detector surrounded by the boron shielding 104. We can separate the boron peak count rate from the rest of the spectrum using one of the methods mentioned above, and plot the boron peak count rate vs. the neutron absorption rate within the boron shield, as shown in FIG. 3. As shown clearly in FIG. 3, the boron peak is a linear function of the neutron absorption rate. Thus, it is a very good thermal and epithermal neutron measurement.

The detection efficiency is moderate compared to other neutron detection techniques. First of all, around 50% of the prompt gamma rays from boron will not enter the detector in this simple configuration. Secondly, the gamma rays entering the detector have a certain probability not to deposit all of their energy so that they will not all score in the full energy peak. To increase the efficiency, it is preferable to use a detector with a high peak-to-Compton ratio.

One benefit of this technique is that one can measure both the gamma and the neutron signal at the same time and location. Generally, for a given neutron logging tool with several gamma detectors, one can have both a gamma and a neutron measurement from a single detector using this technique, instead of only having a gamma ray measurement per detector. In addition, this technique requires very little effort to be implemented in a neutron logging tool with a gamma-ray detector. Providing the neutron measurement at the same time and location as the gamma-ray measurement, this technique can make it possible to measure neutron porosity, hydrogen index (HI), the macroscopic thermal neutron capture cross section (Sigma) of the borehole or the formation, gas saturation (based at least in part on inelastic gamma ray count rates), gamma ray spectroscopy (inelastic and capture) and other formation properties requiring the combination of neutron and gamma measurements. Details regarding such measurements can be found in books such as: D. V. Ellis and J. M. Singer, “Well Logging for Earth Scientists”, second edition, Springer 2007.

Another benefit of this technique is that a scintillation detector can be simultaneously optimized for both inelastic gas detection and inelastic and capture spectroscopy (see Attorney Docket 49.0392, U.S. Application PCT/US10/35718). If a detector with a low resonance integral, such as LaCl₃ is shielded with a layer of boron, it improves the spectroscopy performance by removing the background from most thermal neutron interactions that may occur directly in the detector and that may mask the high energy inelastic and capture gamma rays returning from the formation. Most of these interactions now occur in the Boron layer and the resulting gamma-rays leave at most 0.48 MeV in the detector. These neutron induced interactions are still counted in the total counts during the neutron burst which are typically used for the inelastic gas measurement. By applying an energy cutoff to the total counts above 0.48 MeV and preserving the higher energy counts for the inelastic gas measurement, a single detector can be optimized simultaneously for both measurements. Alternatively, one can attempt to subtract the contribution based on the capture gamma-ray count rate observed after the burst. In a third approach, the subtraction of the gamma-ray counts during the burst could be based on the total count rate in the peak and could include subtracting the contribution of lower energy signals caused by incomplete absorption of the 0.48-MeV gamma ray in the detector or by 0.48 MeV gamma-rays recorded in the detector after scattering in the material surrounding the detector or the logging tool. This could be done by measuring a standard spectrum corresponding to the 0.48-MeV gamma-rays interacting with the crystal. From the total counts in the peak, the number of lower energy counts corresponding to partial energy deposition in the crystal or to backscattering from the material surrounding the detector can be determined.

The neutron detector described here presents a thermal neutron detector. It could be transformed into an epithermal neutron detector by surrounding the Boron layer 104 by a layer of a different neutron absorber, so that only epithermal neutrons will reach the boron layer 104. Such a neutron absorber could comprise a material such as Cd or Gd. A preferred solution would be the use of a layer containing a high concentration of ⁶Li. The advantage of ⁶Li as an absorber is that the reaction ⁶Li(n,α)³H does not result in the emission of gamma-rays and therefore the interaction would not be detected in the scintillation detector, provided that the charged particles created in the reaction do not reach the scintillating material.

Alternatively, the detector could be made directionally sensitive for neutrons by covering a particular part of the scintillator with a layer of boron, while another part would not be covered or would be covered by a different neutron absorber such as Cd, Gd, or ⁶Li.

The tool may be conveyed on wireline, slick-line, drill-pipe (TLC) or coiled tubing or may be part of a bottom hole assembly in a drill string, as part of the basic wellsite system as disclosed and referenced above in Attorney Docket 49.0392, U.S. Application PCT/US10/35718. The tool will contain the necessary electronics to acquire data from the detector(s) and to store them in memory and/or transmit them to the surface (wireline, wired drill pipe, mud pulse and other means of communication to the surface).

FIG. 4 shows a downhole tool in accordance with an embodiment of the disclosure. The downhole tool includes a pulsed neutron source 400 (a radioisotope source like ²⁴¹AmBe or ²⁵²Cf could be used for many applications as well) disposed in a pulsed neutron generator 402, within a tool housing 404. The tool also includes a plurality of detectors 406A, B, and C, respectively, each detector including a photomultiplier 408A, B, and C, and scintillation crystal 410A, B, and C, respectively. Neutron-gamma shielding 412 is disposed between the source and the detectors and three scintillation detectors as described above. While all three detectors in FIG. 4 are shown as being surrounded by ¹⁰B shielding, only one or two of the detectors may be constructed with this shielding.

Also, for some applications a single detector, possibly combined with a neutron monitor could be used. The term “neutron monitor” is intended as a detector placed to measure fast neutrons substantially immediately upon being emitted from the neutron generator 402 to obtain a measurement of the neutron flux from the neutron source. This would allow the construction of a tool with a single detector, which would perform a combined neutron-gamma measurement as described in U.S. Pat. No. 7,365,307, commonly assigned to the assignee of the present disclosure. The number of detectors is not limited to three, as additional detectors can be used. Also, some of the detectors can be neutron detectors (such as ³He detectors).

In some applications, the neutron flux detected by the detector of the invention may be used to obtain a correction signal to determine the total amount of tool background gamma-rays created in the tool housing and other materials surrounding the detector.

In the detector shown in FIG. 1, the scintillator and part of the photomultiplier are surrounded by a layer containing ¹⁰B. However, the detection probability for gamma-rays from the shielding covering the PMT drops rapidly as the distance to the scintillator increases. Scintillators used may be known scintillating materials, including but not limited to, Sodium Iodide (NaI), Lanthanum Chloride (LaCl₃), Lanthanum Bromide (LaBr₃), Yttrium Aluminum Perovskite (YAP), Gadolinium-oxyortho-slicate (GSO), Bismuth Germanate (BGO) to name a few.

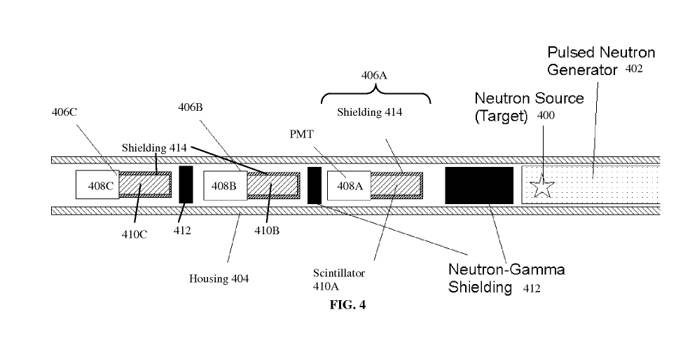

Alternatively, the construction shown in FIG. 5 could be used. As shown in FIG. 5, the PMT window may contain ¹⁰B and may act as a converter to emit gamma-rays. If a hygroscopic scintillator 100 that requires hermetic encapsulation is used, then the exit window from the scintillator 100 (not shown) could be made of a glass window 500 containing a high concentration of ¹⁰B. A transparent optical coupling 504 containing ¹⁰B may be placed between the PMT 102 and the scintillator 100.

While the invention has been described as using a PMT 102 for the photon detection, any other photodetector suitable for the application could be used in conjunction with the scintillator.

While the invention has been described as using a scintillator to detect the gamma-rays other gamma-ray detectors like semi-conductor detectors (like Germanium detectors, Cadmium Zinc Telluride (CZT), Mercuric Iodide (HgI) to name a few) or gas proportional counters (like Xe-proportional counters) could be surrounded by ¹⁰B in a similar way.

For an inelastic gas measurement as disclosed and referenced above in Attorney Docket 49.0392, U.S. Application PCT/US10/35718, an alternative method for achieving a low epithermal background during the burst is to use a boron shielded detector with a scintillator material having a low resonance integral and using a cutoff energy in the acquired gamma-ray spectrum, which is higher than the 0.48 MeV boron peak. The prompt gamma rays from boron thermal neutron absorption are only counted at energy levels equal or lower than the 0.48 MeV. In addition, almost no thermal neutrons can penetrate the boron shielding and generate gamma rays within the detector. Thus, the counts with energy levels higher than the 0.48 MeV boron peak will have a much lower percentage of thermal neutron capture gamma rays generated in the scintillator, and a relatively larger percentage of inelastic gamma rays. This will make the inelastic measurement during the neutron burst less sensitive to thermal and epithermal neutrons, which respond primarily to hydrogen content. Therefore, it can be used to better differentiate gas porosity from water porosity.

The methods of the present disclosure provide a manner of measuring the thermal and epithermal neutron population during the neutron burst. For the inelastic gas measurement, the inelastic measurement during the neutron burst contains the gamma rays from neutron inelastic scattering, as well as some epithermal neutron and thermal neutron prompt gamma rays. Since one can use this method to measure those epithermal and thermal neutron signals during the burst at the same detector, one can also use this measurement to remove the epithermal and thermal neutron signal from the measurement during the neutron burst and to obtain a cleaner measurement of the gamma rays from neutron inelastic scattering. This clean inelastic measurement is an independent measurement to the thermal neutron measurement after the neutron burst. Thus, the two can be used together to differentiate the gas filled porosity from water filled porosity.

The 0.48 MeV boron peak will generally be present in the detector when neutrons are also present. Therefore, one can use it to regulate the detector gain to make sure the boron peak will always appear in the same energy channel. In this way, there is no need to have a radio-isotope source, such as a ¹³⁷Cs, inside the tool. This can be a step towards a fully sourceless tool (i.e. a tool not containing any radioisotope sources) and it can also make it easier to gain regulate a tool that is not communicating with uphole equipment and does not have a large amount of processing power.

Using proper upper and lower energy thresholds just above and below the boron peak, one can measure the MCS time spectrum of the boron peak. This time spectrum corresponds to epithermal and thermal neutron absorption in the boron shielding. Thus, it can be used to measure the formation and/or borehole Sigma. The time spectrum could also be used to calculate an epithermal slowing-down time which is commonly used as an indicator for tool standoff.

Since the MCS spectrum mentioned above corresponds to a neutron measurement, the apparent Sigma based on this spectrum will be different from the apparent Sigma measured from the capture gamma ray time spectrum (i.e. the MCS spectrum associated with energies above 0.48 MeV). The difference can be used in terms of depth-of-investigation, borehole size effect, borehole salinity effect, casing size effect, cement effect, lithology effect, HI effect, and gas effect. Thus, the apparent Sigma based on the boron peak in the spectrum can be a stand-alone Sigma measurement, or can be used to correct the gamma-ray-based Sigma for environmental effects.

For a logging tool with two or more detectors with boron shielding, the ratio of the boron peak measurements from any two detectors can be used to measure the formation and borehole HI. One can also use a ratio of the boron peak measurement from one detector and a capture gamma ray measurement from another detector to measure the formation and borehole HI. These HI measurements are different from the HI measurement based on the capture gamma ray ratio in terms of depth-of-investigation, borehole size effect, borehole salinity effect, casing size effect, cement effect, lithology effect, and gas effect. Thus, these HI measurements can be stand-alone HI measurements, or be used to correct those effects for the HI measurement based on the capture gamma ray ratio.

The boron peak measurement in the detector can be used as an independent count rate to normalize another detector output in order to cancel the absolute neutron output from a pulsed neutron generator which may not be always constant. It can be used to normalize not only the output from another detector, but also the measurements from the current detector itself.

This disclosure also provides a method to measure thermal and epithermal neutrons entering the boron shielding. Such a neutron measurement can be used for other applications which are not mentioned above.

Additional thermal neutron absorbers such as ⁶Li can be added outside the boron shielding to absorb most thermal neutrons and allow some epithermal neutrons to pass through and reach the boron shielding. Thus, the 0.48 MeV prompt gamma rays measured in the detector correspond to the epithermal neutrons only but not the thermal neutrons. This provides a method to measure the epithermal neutrons only. This measurement can be used for the applications mentioned above in addition to others not listed.

The methods herein provide a neutron measurement at the exact same location and time of the gamma detector.

A lead or other heavy metal shield around a Boron wrapped scintillator could be used to improve the signal-to-noise ratio for neutron detection. This can make it a more pure neutron detector, or if the detector is in a high count rate environment, it can be used to increase detection of neutrons versus gamma rays. The preferred reduction of low energy gamma rays coming from the formation can also facilitate the extraction of the neutron signal from the spectrum.

The gamma ray detector can be only partially covered in Boron (e.g. the top or bottom half axially or the front or back half azimuthally) to tune the sensitivity for neutron detection to a different depth of investigation or to alter the sensitivity to the borehole or formation. This technique could, for instance, be used to correct for borehole effects. For azimuthal measurements, it may be necessary to cover the opening in the boron layer with a different neutron absorbing material. Otherwise thermal neutrons entering a scintillation detector with a low neutron capture cross section from the open side will have a high probability of getting absorbed in the shielding on the opposite site. This would greatly reduce the azimuthal sensitivity.

In comparison to presently used Pulsed-Neutron-Capture tools, i.e. tools that measure the macroscopic thermal neutron capture cross section of the formation (Sigma) and/or the borehole (Sigma-Borehole), the apparatus of the present disclosure makes it possible to measure a Sigma, which is virtually free of contributions from neutron capture in the detector and therefore represents a true gamma-ray sigma with the associated deeper depth of investigation. At present, all gamma-ray detector based sigma tools exhibit a mix of signals that comprises neutrons interacting with the tool and with the scintillation crystal (and its shielding) and gamma-rays that are due to neutron capture in the formation and the borehole. Due to the shallower depth of investigation associated with the neutron-neutron based sigma, this increases the borehole contribution and the required borehole correction. This is possible with the apparatus of the present disclosure, if one sets the gamma-ray threshold above 0.48 MeV and if the gamma-ray contribution from neutron capture in the tool is small. The latter can be achieved by proper selection of materials and additional shielding.

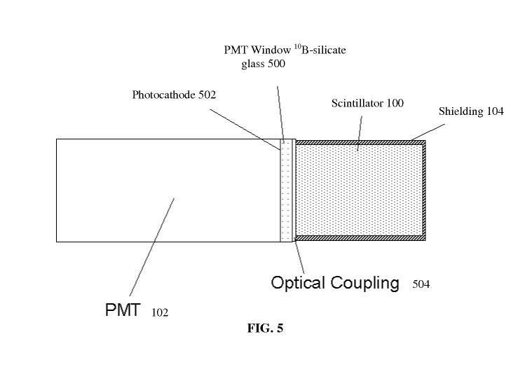

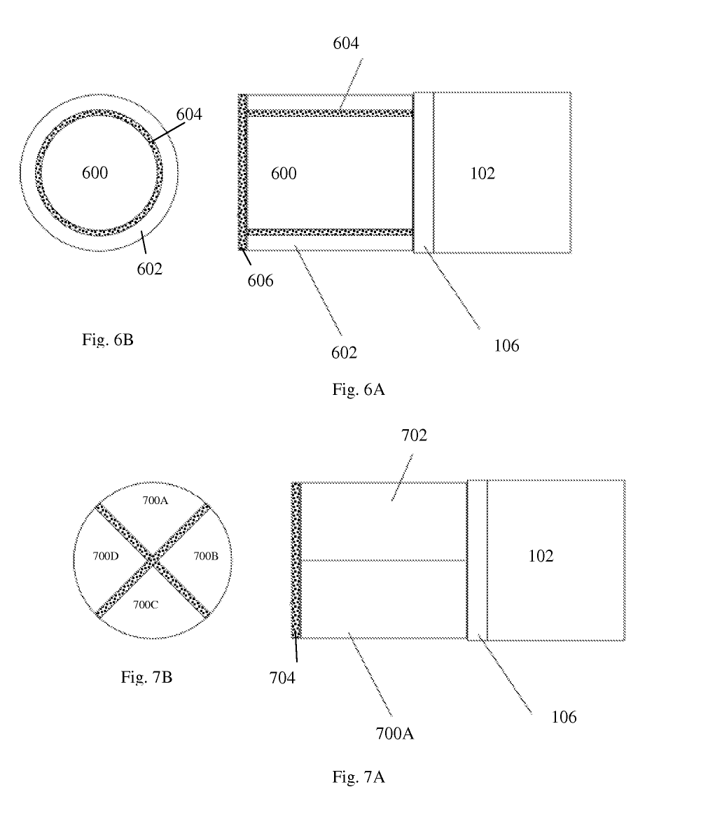

In the embodiments described so far, at least 50% of the gamma-rays will not interact with the scintillator. This can be changed by using multiple/segmented scintillators as indicated in FIGS. 6A and B, 7A and B, and 8. FIG. 6A shows a scintillator consisting of two portions: an inner cylindrical scintillator 600 (though other shapes are equally plausible) and a cylindrical outer scintillator 602 on the outside with a boron layer 604 separating the two, along with an end layer of boron 606. FIG. 6B shows an end view of the configuration of FIG. 6A without an end layer. If the scintillator on the outside is dimensioned in such a way as to insure that most of the 0.48-MeV gamma-rays deposit all their energy, then a significant increase in the neutron sensitivity can be achieved. However, the complex shape of the scintillator and the fact that it is read by a single PMT may compromise the spectral quality (spectral resolution of the assembly). Also, the scintillator should have only a very small neutron capture cross section and resonance integral. The neutron detection probability can be enhanced further by adding a B-layer at the end of the scintillator. However, this layer will have a reduced probability that the 0.48 MeV gamma-ray will be detected. Additionally, the PMT window can be made of a boron-glass (i.e. Borosilicate) possibly made with enriched ¹⁰B.

An alternate embodiment is shown in FIGS. 7A and 7B. As shown in FIGS. 7A and 7B, the scintillator is separated into a plurality of segments 700 (four as shown, 700A, 700B, 700C, and 700D respectively), each of which are separated from the adjacent segments by thin layers of boron 702. Each boron layer is in addition to proper reflectorizing of the scintillator surfaces to minimize light losses. As with the embodiment shown in FIGS. 6A and 7B, an end layer of boron 704 may also be included.

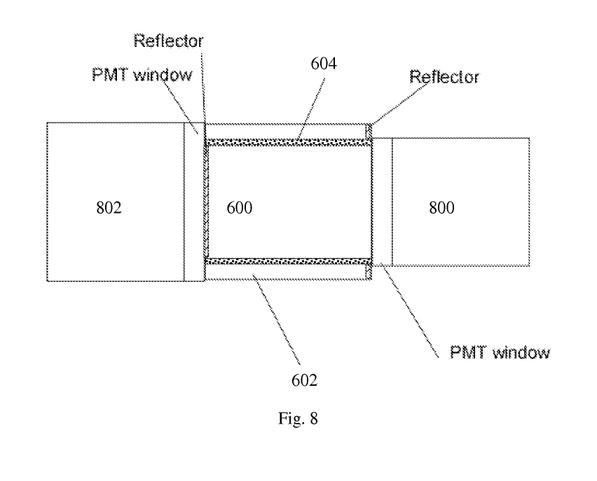

In yet another embodiment, the output of the scintillator(s) could be captured by two PMTs 800 and 802 respectively on opposing sides of the segmented scintillator with an inner scintillator segment 600 and an outer scintillator segment 602 separated by a boron layer 604 as shown in FIG. 8. In addition to the reflecting material typically used surround a scintillation crystal, the opposing ends are reflectorized to ensure that light passes to one or the other of the PMTs 800 and 802.

While the invention has been described in the context of applications in downhole tools, the apparatus of the invention can be used in many applications requiring neutron detection such as industrial applications in nuclear reactors or other nuclear installation, in detection technologies for homeland security and in many nuclear physics measurements.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. An apparatus, comprising:
a gamma ray detector disposed with a layer containing ¹⁰B isotope configured to detect a gamma signal and a neutron signal substantially simultaneously at a single physical location in the apparatus.

2. The apparatus of claim 1, further comprising:
a neutron source configured to emit neutrons.

3. The apparatus of claim 2, further comprising:
a neutron monitor configured to monitor substantially immediate outputs of the neutron source.

4. The apparatus of claim 2, wherein the neutron source is configured to emit neutrons of at least 2 MeV.

5. The apparatus of claim 1, wherein the layer containing ¹⁰B isotope partially covers the gamma ray detector.

6. The apparatus of claim 5, wherein the layer containing ¹⁰B isotope partially covers the top half axially of the gamma ray detector.

7. The apparatus of claim 5, wherein the layer containing ¹⁰B isotope partially covers the bottom half axially of the gamma ray detector.

8. The apparatus of claim 5, wherein the layer containing ¹⁰B isotope partially covers the front half azimuthally of the gamma ray detector.

9. The apparatus of claim 5, wherein the layer containing ¹⁰B isotope partially covers the back half azimuthally of the gamma ray detector.

10. The apparatus of claim 1, wherein the layer containing ¹⁰B isotope substantially wholly covers the gamma ray detector.

11. The apparatus of claim 1, wherein the gamma-ray detector comprises a solid state detector consisting of a material from the group consisting of Germanium, Mercuric Iodide (HgI₂), and Cadmium Zinc Telluride (CZT).

12. The apparatus of claim 1, wherein the gamma-ray detector comprises a gas proportional counter.

13. The apparatus of claim 1, wherein the gamma-ray detector comprises a scintillation detector.

14. The apparatus of claim 13, wherein the scintillation detector is packaged in a housing having a window

15. The apparatus of claim 14, wherein the window of the housing contains ¹⁰B and forms an end layer of the ¹⁰B shielding.

16. The apparatus of claim 1, wherein the gamma-ray detector comprises a photomultiplier tube (PMT) having an entrance window, and a scintillator crystal.

17. The apparatus of claim 16, wherein the entrance window of the photomultiplier contains ¹⁰B to form an end layer covering the scintillation detector.

18. The apparatus of claim 16, wherein the optical coupling layer between the photomultiplier and the scintillation detector contains ¹⁰B.

19. The apparatus of claim 13, wherein the scintillation detector comprises a material selected from the group consisting of Sodium Iodide (NaI(Tl), Lanthanum-Chloride (LaCl₃), Lanthanum Bromide (LaBr₃), Yttrium Aluminum Perovskite (YAP), Bismuth Germanate (BGO), Gadolinium-oxyortho-silicate (GSO).

20. The apparatus of claim 1, further comprising a plurality of gamma-ray detectors, each disposed with a layer containing ¹⁰B isotope configured to detect a gamma signal and a neutron signal substantially simultaneously.

21. The apparatus of claim 1, wherein the gamma-ray detector comprises a first scintillator and a second scintillator separated by a layer containing ¹⁰B isotope.

22. The apparatus of claim 20, wherein the first scintillator comprises a cylindrical inner scintillator and the second scintillator comprises a cylindrical outer scintillator, each surface of each scintillator being reflectorized.

23. The apparatus of claim 20, wherein the first scintillator and second scintillator comprise portions separated from one another by the layer containing ¹⁰B isotope.

24. The apparatus of claim 4, further comprising a second neutron absorber disposed on the portions of the gamma-ray detector not covered by the layer containing ¹⁰B isotope.

25. The apparatus of claim 16, wherein the second neutron absorber comprises Cd or Gd.

26. The apparatus of claim 10, further comprising a second neutron absorber disposed about the gamma ray detector in addition to the layer containing ¹⁰B isotope.

27. The apparatus of claim 26, wherein the second neutron absorber comprises a material not emitting gamma-rays when absorbing neutron such as ⁶Li.

28. The apparatus of claim 27, wherein the second neutron absorbing layer absorbs substantially all thermal neutrons thereby configuring the gamma-ray detector as an epithermal neutron detector.

29. The apparatus of claim 1, further comprising material containing ¹⁰B isotope in the environment of the gamma ray detector in a tool chassis or a detector housing.

30. A method for logging a formation, comprising:
disposing a tool in a wellbore penetrating the formation, wherein the tool comprises a neutron generator and a gamma ray detector disposed with a layer containing ¹⁰B isotope; and
detecting a gamma signal and a neutron signal substantially simultaneously at a single physical location in the tool, the neutron signal being represented by 0.48 MeV gamma-rays generated in the layer containing ¹⁰B-containing about the detector and the gamma-ray signal being generated by neutron interactions with the tool, the wellbore or formation materials other than ¹⁰B.

31. The method according to claim 30, wherein the tool further comprises a neutron monitor configured to monitor substantially immediate outputs of a neutron generator.

32. The method according to claim 30, further comprising detecting a 0.48-MeV prompt gamma ray due to a ¹⁰B (n,α)⁷Li reaction.

33. The method according to claim 32 further comprising counting the number of 0.48-MeV gamma-rays to obtain a neutron measurement.

34. The method of claim 33, wherein the counting comprises determining the total area of the 0.48-MeV gamma-ray peak.

35. The method of claim 33, wherein the number of gamma-rays is determined by setting an energy window in the gamma-ray spectrum, which encompasses the 0.48-MeV gamma-ray peak.

36. The method of claim 34, further comprising inferring the total number of interaction of 0.48-MeV gamma-rays with the detector from the total peak area based on a known ratio of the number of counts in the peak and the total number of 0.48-MeV related gamma-rays.

37. The method of claim 34, further comprising removing contributions from the neighboring 0.511-MeV gamma-ray peak from the total peak area.

38. The method of claim 34, further comprising measuring a gamma-ray signal free of the contributions from the 0.48-MeV ¹⁰B gamma-rays.

39. The method of claim 38, wherein the contribution from ¹⁰B gamma-rays is removed by setting an energy threshold above 0.48 keV and only gamma-rays with energy exceeding such threshold are counted.

40. The method of claim 38, wherein the contribution from the ¹⁰B is removed based on the total counts in the 0.48-MeV peak and the known ratio of the peak area and the total number of gamma-rays caused by the 0.48-MeV gamma-ray interactions.

41. The method of claim 30, further comprising using the neutron signal to determine a thermal neutron porosity, epithermal neutron porosity, or hydrogen index measurement based on the number of neutron counts normalized by the neutron flux.

42. The method of claim 30, further comprising using the time dependent neutron signal rate to determine Sigma.

43. The method according to claim 30, further comprising:
using the detected neutron signal or a gamma ray signal substantially free of neutrons or a combination of both signals to produce any of the following: a neutron porosity measurement, a hydrogen index measurement, a Sigma measurement based on the neutron signal, a Sigma measurement based on the gamma-ray signal, a gas evaluation based on inelastic gamma ray count rates, a gamma ray spectroscopy measurement of inelastic and capture gamma rays and other formation properties requiring the combination of neutron and gamma measurements.
